(19) United States
(12) Patent Application Publication
(10) Pub. No.: US 2025/0375843 A1
(43) Pub. Date: Dec. 11, 2025

(54) SYSTEM AND BOLT EXTRACTOR FOR MANUAL INSERTION/EXTRACTION OF BOLTS

(71) Applicant: Liebherr-Werk Ehingen GmbH, Ehingen (DE)

(72) Inventor: Tobias FREUND, Bibertal (DE)

(21) Appl. No.: 19/226,969

(22) Filed: Jun. 3, 2025

(30) Foreign Application Priority Data
Jun. 3, 2024 (DE) 10 2024 115 384.9

(51) Int. Cl. B23P 19/06

(52) U.S. Cl. CPC B23P 19/06

(57) ABSTRACT

The invention relates to a system for the manual insertion/extraction of bolts for connecting/disconnecting components of a working machine, comprising a bolt extractor, which comprises a displaceable bolt and a rod connected to the bolt or formed in one piece with a bearing element for manual movement of the bolt, as well as a counter-bearing element arranged on one of the components, wherein the bearing element and the counter-bearing element are designed as force application points for receiving a lever element and are arranged such that the rod can be displaced with the bolt by manual application of force to the lever element received in the bearing and counter-bearing elements, thereby enabling the components to be connected/disconnected. The invention also relates to a bolt extractor for a system according to the invention, a component, with a counter bearing and a bolt extractor as well as a working machine, with such a lattice piece.

### CROSS REFERENCE TO RELATED APPLICATION

The present application claims priority to German Patent Application No. 10 2024 115 384.9 filed on Jun. 3, 2024. The entire contents of the above-listed application are hereby incorporated by reference for all purposes.

### TECHNICAL FIELD

The present invention relates to a system for the manual insertion/extraction of bolts for connecting/disconnecting components of a working machine, in particular a crane, and to a bolt extractor therefor.

### BACKGROUND

Individual components are regularly bolted together when assembling working machines. An example of this are lattice pieces of a crane for setting up the boom system, in particular lattice or counter booms, boom extensions as well as centre booms and their bracing frames. The connection points of the components are usually designed as fork-finger connections and must be aligned in order to insert the bolts. As this usually requires increased force, it is known to provide a bolt extractor on one of the components to be connected, which pushes the bolt into or pulls it out of the connection points using an electric or hydraulic actuator. However, due to the drive components installed and to be controlled, such devices are complicated in design and therefore prone to errors. In contrast, mechanical or manual insertion/extraction of the bolt connections by human personnel, for example using a hammer, is more favourable, as it does not require a complex bolt extractor. However, manual insertion/extraction of the bolts can be time-consuming due to the high forces required.

### SUMMARY

Therefore, a solution is being sought for the insertion/extraction of bolts when connecting/disconnecting such components, which knows how to overcome the disadvantages mentioned.

According to the invention, this object is achieved by a as described herein. Advantageous embodiments of the invention result from the following description.

According to the invention, a system for manually inserting or extracting bolts for connecting or disconnecting components of a working machine is proposed, wherein the working machine may in particular be a crane (for example a crawler crane) and the components may be lattice pieces or parts of a divisible lattice piece. The system comprises a bolt extractor, which comprises a displaceable bolt and a rod connected to the bolt or formed in one piece with a bearing element for manual movement of the bolt. By moving the rod, the bolt is displaced and thus inserted or extracted. The rod thus serves as an actuating element for the bolt. The term “rod” is to be interpreted broadly and can refer to an elongated, circular solid or hollow profile, but also to a differently shaped actuating element, for example with an angular or flat cross-section.

The system according to the invention further comprises a counter-bearing element, which is arranged on one of the components to be connected or disconnected via the bolt. The bearing element and the counter-bearing element serve as force application points for holding a lever element, for example an elongated rod. They are designed and arranged in such a way that the rod can be moved with the bolt by manually applying force to the lever element accommodated in the bearing and counter-bearing element, thereby allowing the components to be connected/disconnected. The lever element is supported on the counter-bearing element and pushes or pulls the rod along its longitudinal axis in one direction or the other by applying force (by a human operator) via the contacting of the bearing element. This allows the machine fitter to generate a very high propulsive force for the bolt with normal manual force via the lever arm.

The lever element can be part of the system according to the invention and can, for example, be held in a holder provided on the working machine. Alternatively, the system per se may not comprise a separate lever element and may be designed for use with one only, wherein the working machine installer can use any suitable lever element to move the bolt.

This design enables the bolt to be extracted/inserted manually using the law of leverage, so that no further tools (e.g. cordless screwdriver, impact wrench, bolt extractor cylinder) need to be used or an actuator (e.g. a hydraulic or electric linear drive) provided on the bolt extractor.

Preferably, the bolt extractor is orientated during connection or disconnection (i.e. in its nominal position of use) such that the bolt is displaceable in a vertical direction. The pin is preferably inserted in the direction of gravity, i.e. downwards, or in the opposite direction, i.e. upwards.

In one possible embodiment, it is provided that the bolt extractor does not comprise an actuator for moving the bolt, but in particular comprises exclusively mechanical components. This results in a lightweight, simple, cost-effective and less error-prone mechanism for extracting/inserting bolts. Nevertheless, it is easy to apply the required force by utilising the leverage effect via the bearing and counter-bearing elements.

In another possible embodiment, it is provided that the counter-bearing element comprises at least two receptacles for receiving the lever element. The receptacles are preferably closed and each provide a secure mount for the lever element. The receptacles are preferably arranged along the direction of movement of the bolt or rod. This allows the lever element to be inserted into a suitable receptacle in different positions of the rod and moved via the lever effect of the bolt. The distances between the receptacles are suitably chosen. Preferably, a large number of receptacles are provided so that there is always a suitable receptacle for holding the lever element in each end position of the bolt and also in the intermediate positions. The counter-bearing element can be designed as a receiving rake.

In another possible embodiment, it is provided that the bearing element is arranged at an end of the rod opposite the bolt and preferably comprises an eye or a hook element. The lever element can be pushed through the eyelet or inserted into the hook element and placed in the counter-bearing element. A force is then applied to the end of the lever element opposite the counter-bearing element, which exerts a lever force on the rod and moves it.

In another possible embodiment, it is provided that the bolt extractor comprises a locking mechanism for locking the rod in two different positions. The positions can be the two end positions (“bolted” and “extracted”). The locking of the rod prevents unintentional movement of the bolt.

The locking mechanism preferably comprises a locking element, in particular a locking bolt, which can be inserted into recesses in the rod in the aforementioned positions, thereby blocking axial displacement of the rod. The recesses in the rod can be designed as circumferential grooves (locking grooves). The locking element can in turn be secured in a locked position, e.g. via a locking pin or split pin.

In another possible embodiment, it is provided that the bolt extractor comprises a latching mechanism with a latching pin movable between a latching position and a release position. The rod comprises a plurality of axially adjacent latching grooves in which the latching pin engages in its latching position. Latching pins and latching grooves form a latching mechanism. For this purpose, the latching pin is designed in such a way that, when engaged in a latching groove, it blocks movement of the rod in a first axial direction (in particular gravity-induced lowering of the rod) and preferably enables movement of the rod in the opposite direction (in particular upwards). Preferably, the latching pin is also designed in such a way that it allows the rod to move in both axial directions in the release position.

Due to the latching mechanism, gravity-induced lowering of the rod is blocked in particular, which simplifies the assembly and disassembly process as the rod is held by itself. If the bolt or rod is to be moved downwards, the latching pin must first be moved to its release position. On the other hand, the bolt can preferably be lifted at any time, wherein the latching pin, due to its shape and arrangement, preferably falls automatically into the next latching groove due to gravity (and/or due to a spring element) when it jumps over a latching groove.

Depending on the arrangement of the bolt extractor, the direction of gravity blocked by the latching pin can correspond to the bolting direction or the extracting direction.

In another possible embodiment, it is provided that the latching mechanism comprises a blocking element that, in a blocking position, blocks movement of the latching pin from the latching position to the release position. This prevents the latching pin from moving unintentionally to the release position and the rod from dropping due to gravity. To release the latching pin, it may be necessary to remove the blocking element. Alternatively, the blocking element can be permanently mounted and can be moved into an open position in order to release movement of the latching pin between the release position and the latching position. The blocking element can be designed as a securing pin or securing spring. The blocking element can be mounted on a bracket of the bolt extractor or on the latching pin itself.

In another possible embodiment, it is provided that the system comprises a mount or bracket in which the rod is guided between the bolt and the bearing element. The aforementioned latching mechanism and/or locking mechanism can be connected to the mount or integrated into it. Preferably, the mount is arranged on the same component as the counter-bearing element. The mount can be made up of several parts.

In another possible embodiment, it is provided that the rod has a first mechanical stop that, in a first end position of the bolt, in particular abuts against a connection means of one of the components that can be bolted by means of the bolt and blocks further movement of the rod. The first mechanical stop can be designed as a circumferential projection on the rod.

Alternatively or additionally, the rod may comprise a second mechanical stop that, in a second end position of the bolt, abuts against a mount of the system guiding the rod and blocks further movement of the rod. The second mechanical stop can be designed as a circumferential projection on the rod.

The first and/or second mechanical stop can be arranged between the bolt and the previously described latching grooves.

The first and second mechanical stops can be formed on a section of the rod with an enlarged diameter.

The end positions of the bolt, which are limited by the first and second mechanical stops, can be the “bolted” and “extracted” positions.

In another possible embodiment, it is provided that the system comprises a first bolt extractor for connecting/disconnecting first connection means (in particular fork-finger connection points) of the components and comprises a second bolt extractor for connecting/disconnecting second connection means (in particular fork-finger connection points) of the components, wherein the first and second bolt extractors are preferably arranged such that their bolts are aligned coaxially to one another.

A first bolt extractor can be provided for connecting/disconnecting upper connection means and arranged underneath so that the bolt is pushed upwards for bolting. Accordingly, a second bolt extractor can be provided for connecting/disconnecting lower connection means and arranged above them so that the bolt is pushed downwards for bolting.

In another possible embodiment, it is provided that the bolt has a preferably circumferential and/or conically shaped chamfer at its end facing away from the bearing element in order to facilitate insertion of the bolt into a connection means to be bolted.

The invention also relates to a bolt extractor for a system according to the invention. This has the same features and properties as those described for the bolt extractor in relation to the system according to the invention, so that the previous explanations also apply to the bolt extractor according to the invention. This is therefore the bolt extractor of the system according to the invention described above.

The invention also relates to a component having a counter bearing and a bolt extractor of the system according to the invention. The component can be a lattice piece, wherein the connection to be bolted can be used to connect two lattice pieces (longitudinal connection), for example. The component can also be a lattice piece part of a longitudinally divisible lattice piece, wherein the connection to be bolted can serve to connect the lattice piece parts (cross connection). In general, however, the system according to the invention can be used to connect/disconnect any components of a working machine and can be provided on the corresponding components.

The invention also relates to a longitudinally divisible lattice piece for a lattice boom, which comprises two lattice piece parts that can be detachably connected to one another, wherein each of the lattice piece parts comprises two corner posts extending in the longitudinal direction and at least two cross-connecting structures firmly connected to the corner posts. The lattice piece parts can be detachably connected to one another via connection means (cross connection) arranged on the cross-connecting structures, wherein a counter bearing and a bolt extractor of the system according to the invention are arranged on at least one of the lattice piece parts. The connection means of the cross-connecting structures can be connected/disconnected by means of the system. At least one counter bearing and one bolt extractor of the system according to the invention can be provided on each of the lattice piece parts.

The lattice piece can be split longitudinally to provide a wider lattice boom with increased lateral rigidity, at least in sections, for crane operation, but to achieve a smaller width for transport in a transport position in order to comply with legal requirements regarding maximum permissible transport dimensions.

In one possible embodiment, it is provided that the cross-connecting structures are designed as prismatic truss structures with triangular cover surfaces and comprise upper and lower leg bars, which are each firmly connected to one of the corner posts and together with this form an upper and a lower triangular cover surface. The upper and lower leg bars converge at their ends facing away from the corner posts in an upper and a lower tip. These upper and lower tips are connected to each other via a post running in particular perpendicular to the corner posts.

The counter bearing and the bolt extractor of the system according to the invention are now arranged on at least one of the cross-connecting structures, namely on the said post, wherein the connection means to be bolted are arranged in particular on the lower and/or on the upper tip of the prismatic cross-connecting structure. Preferably, there are upper and lower connection means at both tips and an upper bolt extractor (including upper counter-bearing element) is attached to the post below the upper connection means and a lower bolt extractor (including lower counter-bearing element) is attached to the post above the lower connection means. The bolt extractors are therefore located in particular between the upper and lower connection means.

The invention also relates to a working machine. This may be a crane, in particular a mobile crane such as a crawler crane. The working machine preferably comprises an undercarriage having a chassis, in particular a crawler chassis, and an upper carriage mounted on the undercarriage so that it can rotate about a vertical axis of rotation. A lattice boom is pivoted to the upper carriage about a horizontal luff axis. The lattice boom comprises at least one lattice piece according to the invention. Preferably, the lattice boom forms the main boom of the working machine. Further attachments, such as a tip, can be fitted to this. The working machine can furthermore have a derrick boom mounted on the upper carriage.

### BRIEF DESCRIPTION OF THE FIGURES

Further features, details and advantages of the invention result from the following exemplary embodiments explained with the help of the figures. In the drawings:

FIG. 1: shows a side view of the system according to the invention according to an exemplary embodiment on a lower connection point of a lattice piece;

FIG. 2: shows a side view of the system according to the invention on an upper connection point of a lattice piece;

FIG. 3: shows the system according to the invention when a force is exerted by means of a lever element;

FIG. 4: shows a perspective view of the rod of the bolt extractor according to the invention according to an exemplary embodiment;

FIG. 5: shows a perspective view of an exemplary embodiment of the latching pin;

FIG. 6: shows a plan view of a lattice piece according to the invention according to an exemplary embodiment;

FIG. 7: shows a side views of the lattice piece according to FIG. 6; and

FIG. 8: shows a side view of a working machine according to the invention according to an exemplary embodiment.

### DETAILED DESCRIPTION

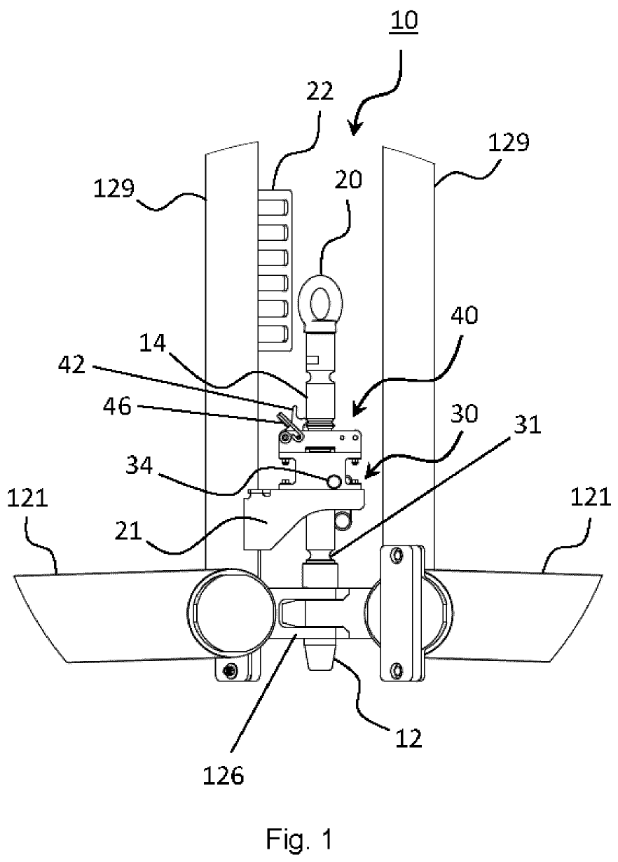

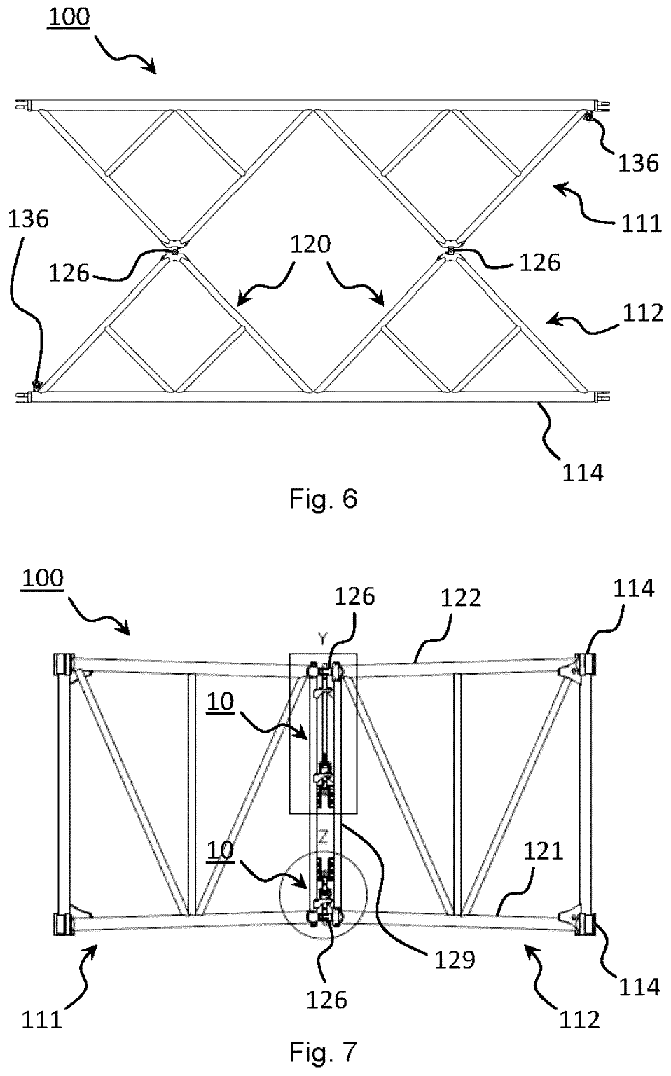

FIG. 1 shows an exemplary embodiment of the system according to the invention in a side view. The system comprises a bolt extractor 10 and a counter-bearing element 22. In the specific exemplary embodiment shown, these are arranged on a post 129 of a longitudinally divisible lattice piece 100 extending between upper and lower connection means 126 (see FIGS. 6-7), but can in principle be used on any boltable components. The following explanations with regard to the system according to the invention are therefore independent of the components or the exemplary embodiment of the lattice piece.

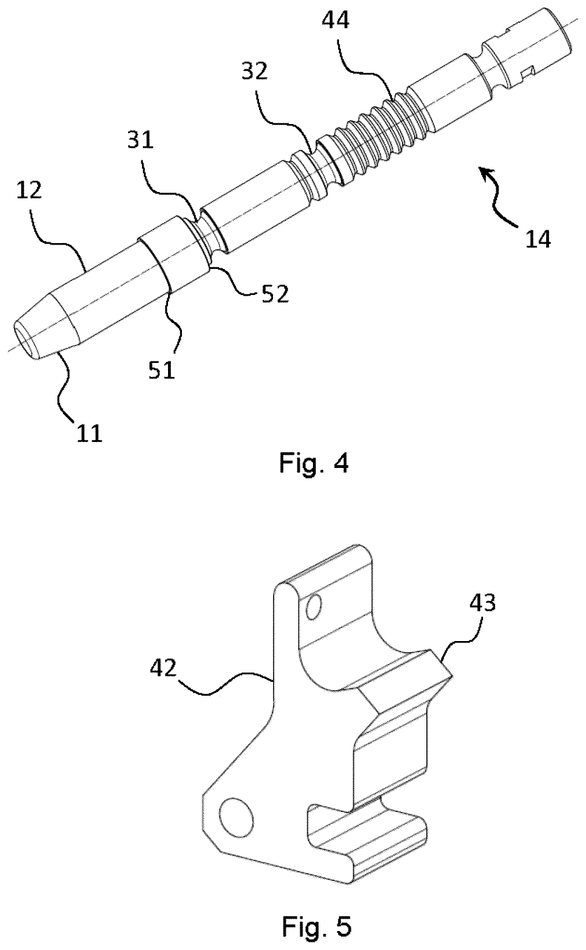

The bolt extractor 10 comprises a rod 14, which is displaceably guided or mounted in a mount 21 and at the end of which facing the connection means 126 a bolt 12 is arranged for bolting the connection means 126. The bolt 12 can be formed in one piece with the rod 14 or connected to it via fastening means. A perspective view of an exemplary embodiment of the rod 14 is shown in FIG. 4.

The bolt 12 can have a circumferential chamfer 11 (insertion chamfer) at its end facing away from the rod 14 in order to facilitate insertion into the bolt openings of the connection means 126 (see FIG. 4).

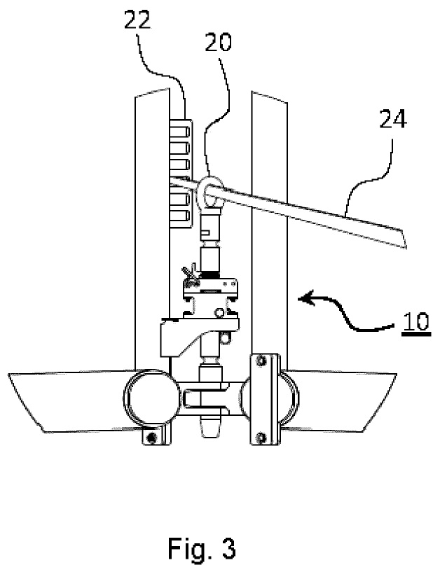

The system according to the invention enables the bolt 12 to be inserted/extracted without an additional drive. For this purpose, a bearing element 20 arranged at the end opposite the bolt 12 and the counter-bearing element 22 arranged on one of the components (in the example of FIG. 1: on one of the posts 129) interact in such a way that they can be used in combination with a lever element 24 (see FIG. 3) to manually displace the rod 14 and thus the bolt 12. FIG. 3 shows an example of a possible insertable lever element 24, which can be designed as an elongated rod or elongated plate.

The bearing element 20 can be designed as an eyelet arranged at the front end of the rod 14 opposite the bolt 12. The counter-bearing element 22 has a plurality of receptacles arranged one above the other in the bolt insertion direction, wherein each receptacle can absorb a large force. The counter-bearing element 22 of the exemplary embodiment of FIG. 1 is designed as a rake with a plurality of receptacles or recesses. Each receptacle is closed and provides a secure mount for the lever element 24.

The bolt 12 is therefore moved by means of power transmission through a simple lever. The lever element 24 can be inserted through the bearing element 20 into a receptacle of the counter-bearing element 22. The distances between the receptacles are suitably chosen. This means that a fitter can generate a very high propulsive force for the bolt 12 with normal human hand force via the lever arm formed. The bolt 12 is retracted in the opposite direction.

The bolt extractor 10 can preferably be designed for securely extracting/inserting the bolt in a vertical direction. For this purpose, the bolt extractor can comprise a latching mechanism 40, which ensures that the rod 14 does not drop unintentionally due to gravity. The latching mechanism 40 can comprise a pivoted latching pin 42, which engages in latching grooves 44 formed on the rod 14 and produces a known latching mechanism. As shown in FIG. 4, the latching grooves 44 can be designed as grooves or milled recesses running around the rod 14. A plurality of latching grooves 44 can be arranged axially one above the other.

The latching pin 42 can be pivoted about a pivot axis perpendicular to the longitudinal axis of the rod and can be secured by means of a blocking element 46. The latching pin 42 can be moved between a latching position, in which a latching nose 43 of the latching pin 42 (see FIG. 5, which shows an exemplary embodiment of the latching pin 42 in a perspective view) engages in the latching grooves 44, and a release position pivoted away from the rod 14. In the release position, the rod 14 can be moved freely upwards or downwards.

The blocking element 46 serves to limit the pivoting movement of the latching pin 42 such that it cannot move into the release position, and ensures that when the edge between two latching grooves 44 is passed over, the force of the weight moves the latching pin 42 back against the rod 14 and it thus re-engages in the next latching groove 44. The blocking element 46 can be designed as a securing spring, which can be removed from the latching pin 42. Alternatively or additionally to a gravity-based movement of the latching pin 42 when travelling over the edge between two latching grooves 44, a spring element can be provided that presses the latching pin 42 against the rod 14.

The latching pin 42 can be designed such that, in the latching position, downward movement of the rod 14 (in the direction of gravity) is blocked, while upward movement is enabled. The latching grooves 44 co-operate with the latching pin 42 in such a way that they bring the latching pin 42 into the engagement position when moving in a positive axial direction (upwards). The connection is held in this position independently (on the one hand due to the weight of the latching pin 42 and on the other hand due to the direction of the force introduced into the latching pin 42 by the rod 14).

In the exemplary embodiment shown in FIG. 1, the locking spring 46 must be removed to insert the bolt 12 (movement in the negative axial direction, i.e. downwards), the latching pin 42 must be folded back into the release position and the locking spring 46 must be reinserted. As a result, the latching pin 42 remains disengaged.

In the exemplary embodiment of FIG. 1, the mount 21 is also arranged on the post 129 to which the counter-bearing element 22 is fastened. The mount 21 serves as a retaining link, which for the bolt 12 defines the longitudinal axis and alignment with the longitudinal axis of the connection means 126 to be bolted (in the example of FIG. 1, these are fork-finger connection points). Depending on the length of the rod 14, there may be more than one mount 21.

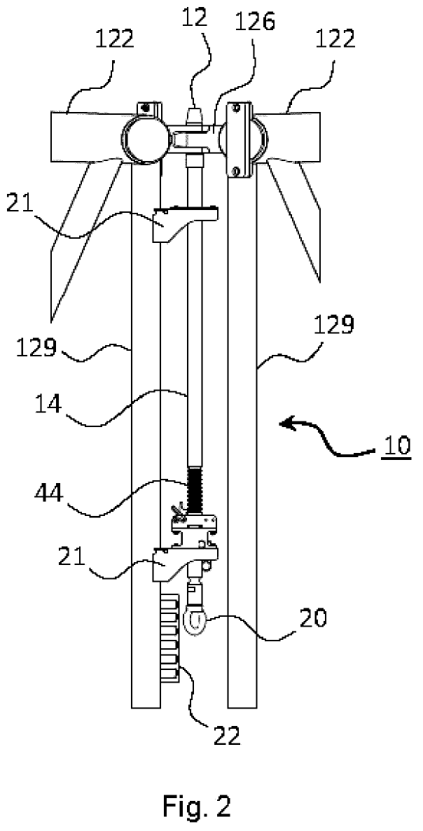

FIG. 2 shows a second bolt extractor 10 with associated counter-bearing element 22. In the lattice piece of FIG. 1, these can serve to connect the upper connection means and can be arranged in such a way that the longitudinal axes of the rods 14 or bolts 12 of both bolt extractors 10 run coaxially. The structure is identical to that of FIG. 1 except for the rod 14, which is longer and is therefore guided in two mounts 21. Furthermore, in the upper bolt extractor of FIG. 2, the insertion of the bolt 12 takes place in a positive axial direction (i.e. upwards).

As can be seen in the exemplary embodiment of the rod 14 of FIG. 4, the rod can have two mechanical stops 51, 52. These can be formed as edges or shoulders of a section of the rod 14 with an increased diameter between the bolt 12 and the latching grooves 44. As can be seen in combination with FIG. 1, a second mechanical stop 52 can serve to define a second or upper end position (“extracted”) of the bolt 12 by abutting against the mount 21, while the opposite first stop 51 abuts against the connection means 126 at the bottom and defines a first, lower end position (“bolted”) of the bolt 12.

In order to secure the bolt in its end positions, the bolt extractor can comprise a locking mechanism 30 (see FIG. 1). For this purpose, the rods 14 can each have a recess 31, 32 at two suitably selected positions at an axial distance from one another, into which a locking element 34 can be inserted. The locking element 34 can be designed as a locking bolt extending transversely to the longitudinal axis of the rod (see FIG. 1). The recesses 31, 32 can be formed as circumferential grooves or milled recesses on the rod 14. A first recess 31 is located closer to the bolt 12 (and in particular in the region of the second mechanical stop 52) than a second recess 32 (which may be arranged in particular in the region of the latching grooves 44). The recesses 31, 32 can be formed between the bolt 12 and the latching grooves 44.

To unlock the rod 14 so that it can be moved in the axial direction, the locking bolt 34 is extracted and preferably placed in a parking position (not shown). The rod 14 can now be moved to the other end position. If this is done against the direction of gravity (in FIG. 1: upwards to extract the bolt 12; in FIG. 2 upwards to insert the bolt 12), this is preferably possible without moving the latching pin 42 into its release position. If the movement is in the direction of gravity, the latching bolt 42 must preferably be moved to the release position as described above. Once the other end position has been reached, the locking bolt 34 can be pushed in again. The locking bolt 34 can be secured by means of a securing pin or split pin.

The counter-bearing element 22 preferably has a plurality of receptacles to enable the rod 14 to be levered over an extended path. Once the bolt 12 has travelled a certain distance, the lever element 24 can be pulled. The latching pin 42 holds the bolt 12 in position. The lever element 24 can be repositioned (i.e. inserted into a different receptacle of the counter-bearing element 22) so that it can be levered again and the bolt 12 travels a further distance. This process is repeated until the bolt 12 reaches its end position.

FIG. 6 shows a plan view of an exemplary embodiment of the lattice piece 100 already partially shown in FIGS. 1-3, while FIG. 7 shows a lateral view along the longitudinal axis (i.e. along the corner posts). The lattice piece 100 is divisible in the longitudinal direction and comprises two lattice piece parts 111, 112 that can be detachably connected to one another via a plurality of connection means 126. Each lattice piece part 111, 112 comprises two corner posts 114, that extend in the longitudinal direction of the lattice piece 100 and can have longitudinal connection means at their ends in the form of fork-finger connection points, via which the lattice piece 10 can be connected to further lattice pieces. The corner posts 114 may be connected to each other via a plurality of diagonal bars and vertical bars extending perpendicular to the corner posts 114.

The lattice piece parts 111, 112 each comprise a plurality of cross-connecting structures 120 on which the connection means 126 for the cross-connections are arranged. In the exemplary embodiment shown, the cross-connecting structures 120 form prismatic truss structures with a triangular base. The cross-connecting structures 120 each comprise two lower leg bars 121, which are firmly connected to the lower corner post 114, and two upper leg bars 122, which are firmly connected to the upper corner post 114. The lower leg bars 121 of a cross-connecting structure 120 extend at an acute angle to the lower corner post 114 and converge at a tip facing away from the corner post 114. Similarly, the upper leg bars 122 of a cross-connecting structure 120 extend at the same acute angle to the lower corner post 114 and converge at a tip facing away from the corner post 114.

As can be seen in FIG. 6, the connection means 126, which form the detachable cross-connecting structures of the lattice piece parts 111, 112, are arranged at the upper and lower tips of the prismatic cross-connecting structures 120 formed by the upper and lower leg bars 121, 122. The upper and lower tips of a cross-connecting structure 120 are thereby connected to each other by posts 129 extending perpendicularly to the corner posts 114. As can be seen in FIGS. 1-3, the bolt extractors 10 and counter-bearing elements 22 can be arranged on these posts 129, between the connection means 126.

The lattice piece parts 111, 112 can additionally have holding connection means 136 in the form of fork-finger connection points, which can be arranged at the ends of the corner posts 114 in the region of the longitudinal connection means (see FIG. 6). In the transport position of the lattice piece 100, in which the cross-connections of the lattice piece parts 111, 112 are released and the lattice piece parts 111, 112 are offset longitudinally relative to one another and pushed into one another via the cross-connecting structures 120 (smaller transport width), the connection means 126 can be bolted to the retaining connection means. As the bolt extractors 10 are attached to the posts 129 of the cross-connecting structures 120, these can also be used for extracting/inserting the bolts 12 of the retaining connections (bolting of connection means 126 and retaining connection means 136).

Of course, the lattice piece 100 shown is only one possible example of a lattice piece whose connections can be produced or separated with the aid of the system according to the invention.

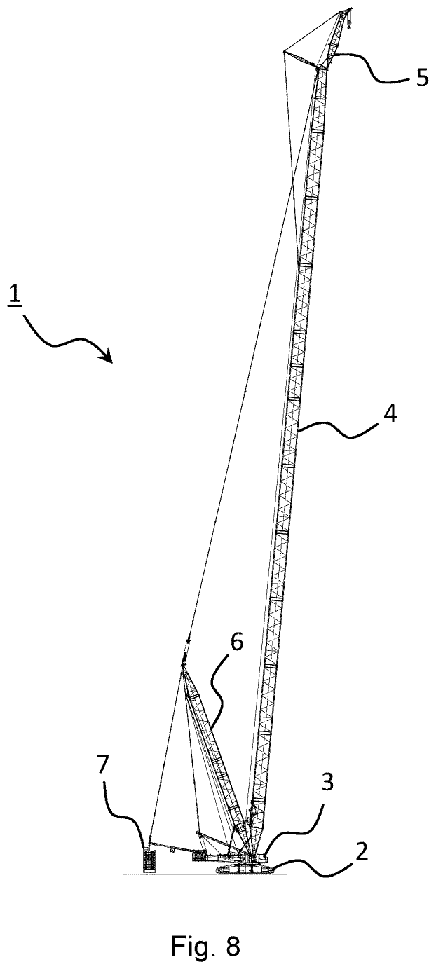

FIG. 8 shows a side view of a possible exemplary embodiment of the working machine 1 according to the invention, which comprises a boom 4 having one or more lattice pieces 10 according to the invention. The working machine of the exemplary embodiment in FIG. 8 is a crawler crane 1 with an undercarriage 2 with crawler chassis and an upper carriage 3 mounted on the undercarriage 2 so as to rotate about a vertical axis of rotation, to which the boom 4 is pivoted about a horizontal luff axis. The boom 4 is the main boom and can carry a tip 5. The crawler crane 1 can have a derrick boom 6 and a derrick ballast 7. The system according to the invention could also be used to connect parts of the derrick boom or other crane components.

### LIST OF REFERENCE NUMERALS

1 Working machine
2 Undercarriage
3 Upper carriage
4 Boom
5 Tip
6 Derrick boom
7 Derrick ballast
10 Bolt extractor
11 Chamfer
12 Bolt
14 Rod
20 Bearing element
21 Mount
22 Counter-bearing element
24 Lever element
30 Locking mechanism
31 First recess
32 Second recess
34 Locking element
40 Latching mechanism
42 Latching pin
43 Latching nose
44 Latching groove
46 Blocking element
51 First mechanical stop
52 Second mechanical stop
100 Lattice piece
111 First lattice piece part
112 Second lattice piece part
114 Corner post
120 Cross-connecting structure
121 Lower leg bars
122 Upper leg bars
126 Connection means
129 Post
136 Retaining connection means

1. System for the manual insertion/extraction of bolts for connecting/disconnecting components of a working machine comprising a bolt extractor, which comprises a displaceable bolt and a rod connected to the bolt or formed in one piece with a bearing element for manual movement of the bolt, as well as a counter-bearing element arranged on one of the components, wherein the bearing element and the counter-bearing element are designed as force application points for receiving a lever element and are arranged such that the rod can be displaced with the bolt by manual application of force to the lever element received in the bearing and counter-bearing elements, thereby enabling the components to be connected/disconnected.

2. System according to claim 1, wherein the bolt extractor does not comprise an actuator for moving the bolt, but comprises exclusively mechanical components.

3. System according to claim 1, wherein the counter-bearing element comprises at least two receptacles for receiving the lever element, which are arranged along the direction of movement of the bolt.

4. System according to claim 1, wherein the bearing element is arranged at an end of the rod opposite the bolt and comprises an eye or a hook element.

5. System according to claim 1, wherein the bolt extractor comprises a locking mechanism for locking the rod in two different positions, wherein the locking mechanism comprises a locking element, which can be pushed into recesses of the rod in the two positions and thereby blocks axial displacement of the rod.

6. System according to claim 1, wherein the bolt extractor comprises a latching mechanism with a latching pin movable between a latching position and a release position, wherein the rod comprises a plurality of axially adjacent latching grooves in which the latching pin engages in its latching position, wherein the latching pin is designed such that, when engaged in a latching groove, it blocks movement of the rod in a first axial direction.

7. System according to claim 6, wherein the latching mechanism comprises a blocking element, which, in a blocking position, blocks a movement of the latching pin from the latching position into the release position, wherein the blocking element is removable or movable into an opening position in order to release a movement of the latching pin between the release position and the latching position.

8. System according to claim 1, comprising at least one mount in which the rod is guided between the bolt and the bearing element, wherein the mount is arranged on the same component as the counter-bearing element.

9. System according to claim 1, wherein the rod has a first mechanical stop, which is formed as a circumferential projection and which, in a first end position of the bolt, and/or wherein the rod has a second mechanical stop (52) formed as a circumferential projection, which in a second end position of the bolt abuts against a mount of the system guiding the rod and blocks further movement of the rod.

10. System according to claim 1, comprising a first bolt extractor for connecting/disconnecting first connection means of the components and comprising a second bolt extractor for connecting/disconnecting second connection means of the components, wherein the first and second bolt extractors are arranged such that their bolts are aligned coaxially to one another.

11. Bolt extractor for a system according to claim 1.

12. Component having a counter bearing and a bolt extractor of the system according to claim 1.

13. Longitudinally divisible lattice piece for a lattice boom, comprising two lattice pieces that can be detachably connected to one another, wherein each of the lattice piece parts comprises two corner posts extending in the longitudinal direction and at least two cross-connecting structures firmly connected to the corner posts, wherein the lattice piece parts can be detachably connected to one another via connection means arranged on the cross-connecting structures, wherein a counter bearing and a bolt extractor of the system according to claim 1 are arranged at least on one of the lattice piece parts, wherein connection means of the cross-connecting structures can be connected/disconnected by means of the system.

14. Lattice piece according to claim 13, wherein the cross-connecting structures are formed as prismatic lattice structures with triangular cover surfaces and comprise upper and lower leg bars, which are each firmly connected to one of the corner posts and together with the latter form an upper and a lower triangular cover surface, wherein the upper and lower leg bars each converge at their ends facing away from the corner posts in an upper and a lower tip and the upper and lower tips are connected to one another via a post.

15. Working machine, comprising an undercarriage with a chassis, an upper carriage mounted on the undercarriage so as to rotate about a vertical axis of rotation, and a lattice boom deflected on the upper carriage, which comprises at least one lattice piece according to claim 1.
